(19) United States
(12) Patent Application Publication
(10) Pub. No.: US 2024/0018928 A1
(43) Pub. Date: Jan. 18, 2024

(54) FUEL INJECTION VALVE

(71) Applicant: DENSO CORPORATION, Kariya-city (JP)

(72) Inventor: Tetsuya YOSHIMURA, Kariya-city (JP)

(21) Appl. No.: 18/359,306

(22) Filed: Jul. 26, 2023

Related U.S. Application Data
(63) Continuation of application No. PCT/JP2022/002001, filed on Jan. 20, 2022.

(30) Foreign Application Priority Data
Jan. 29, 2021 (JP) 2021-013252

(51) Int. Cl. F02M 61/18; F02M 61/10

(52) U.S. Cl. CPC F02M 61/1806; F02M 61/10; F02M 61/1886

(57) ABSTRACT

A fuel injection valve concludes a nozzle and a needle. The nozzle includes nozzle holes extending through a nozzle hole inlet. At least one of the nozzle holes is a specific nozzle hole. A nozzle hole outlet of the specific nozzle hole has a flat shape with a major axis and a minor axis. In a projection of the specific nozzle hole in a direction of the nozzle hole axis, a cross-sectional length of the nozzle hole outlet is longer than a cross-sectional length of the nozzle hole inlet in a cross section, and a cross-sectional length of the nozzle hole outlet is shorter than a cross-sectional length of the nozzle hole inlet in a cross section. The specific nozzle hole has an area ratio of 1.5 or more.

### CROSS REFERENCE TO RELATED APPLICATIONS

The present application is a continuation application of International Patent Application No. PCT/JP2022/002001 filed on Jan. 20, 2022, which designated the U.S. and claims the benefit of priority from Japanese Patent Application No. 2021-013252 filed on Jan. 29, 2021. The entire disclosures of all of the above applications are incorporated herein by reference.

### TECHNICAL FIELD

The present disclosure relates to a fuel injection valve.

### BACKGROUND

Conventionally, there have been known techniques for spraying an entire space using a plurality of nozzle holes.

### SUMMARY

A fuel injection valve of the present disclosure includes a nozzle and a needle. The nozzle is centered on a valve axis. The nozzle includes a suck chamber, nozzle holes, and a valve seat. A suck chamber is provided in a bottom of a fuel passage. The nozzle holes penetrate from a nozzle hole inlet formed in a bottom of the suck chamber to a nozzle hole outlet formed in an outer wall of the nozzle, and fuel in the fuel passage is injected outside through the nozzle holes. The valve seat is formed in an annular shape around the suck chamber. The needle is provided inside the nozzle to be reciprocatable in the valve axis. The needle opens and closes the valve seat to switch between injecting and shutting off fuel.

### BRIEF DESCRIPTION OF DRAWINGS

The details of one or more embodiments are set forth in the accompanying drawings and the description below. Other features and advantages will be apparent from the description and drawings, and from the claims. In the drawings,

FIG. 1 is a cross-sectional view illustrating an overall configuration of a fuel injection valve according to the present embodiment;

FIG. 2 is an enlarged cross-sectional view of Part II in FIG. 1;

FIG. 3A is a view taken in a direction of arrow IIIA in FIG. 2;

FIG. 3B is a view taken in a direction of arrow IIIB in FIG. 2;

FIG. 4A is a cross-sectional view schematically illustrating of a specific nozzle hole in a major axis direction of a nozzle hole outlet;

FIG. 4B is a cross-sectional view schematically illustrating of the specific nozzle hole in a minor axis direction of the nozzle hole outlet;

FIG. 5 is a perspective view schematically illustrating of the specific nozzle hole;

FIG. 6 is a projection view of the specific nozzle hole in an axial direction of the nozzle hole (VI direction in FIG. 4A);

FIG. 7 is a cross-sectional view of a bottom of a nozzle in a fuel injection valve of a comparative example;

FIG. 8 is an enlarged view of a tapered nozzle hole of FIG. 7;

FIG. 9 is a cross-sectional view taken along line IXA-IXA and line IXB-IXB in FIG. 7,

FIG. 10 is a view taken in a direction of arrow X in FIG. 7;

FIG. 11 is a side view schematically illustrating of a spray corresponding to FIG. 10;

FIG. 12 is a cross-sectional view taken along line XII-XII in FIG. 11;

FIG. 13 is a schematic diagram of a spray arrangement when a taper angle is small;

FIG. 14 is a schematic diagram of a spray arrangement when a taper angle is large;

FIG. 15 is a side view schematically illustrating of a spray corresponding to FIGS. 13 and 14;

FIG. 16 is a schematic diagram of a spray arrangement for illustrating a problem-solving concept according to the present embodiment,

FIG. 17A is a projection view of the specific nozzle hole in the axial direction of the nozzle hole when an area ratio of the nozzle hole is small;

FIG. 17B is a projection view of the specific nozzle hole in the axial direction of the nozzle hole when the area ratio of the nozzle hole is large;

FIG. 18 is a diagram showing a relationship between a taper angle, a liquid-filling angle and an actual injection angle with respect to the area ratio;

FIG. 19A is a cross-sectional view of the specific nozzle hole illustrating a definition of the taper angle;

FIG. 19B is a cross-sectional view of the specific nozzle hole illustrating a definition of the liquid-filling angle;

FIG. 20 is a cross-sectional view of the specific nozzle hole illustrating the actual injection angle with CFD analysis;

FIG. 21 is a diagram illustrating variations in a shape of the nozzle hole inlet;

FIG. 22 is a diagram illustrating variations in a shape of the nozzle hole outlet;

FIG. 23A is a diagram illustrating an arrangement of nozzle hole outlets according to a first embodiment;

FIG. 23B is a diagram illustrating an arrangement of sprays according to the first embodiment;

FIG. 24A is a diagram illustrating an arrangement of nozzle hole outlets according to a second embodiment;

FIG. 24B is a diagram illustrating an arrangement of sprays according to the second embodiment;

FIG. 25A is a diagram illustrating an arrangement of nozzle hole outlets according to a third embodiment;

FIG. 25B is a diagram illustrating an arrangement of sprays according to the third embodiment;

FIG. 26A is a diagram illustrating an arrangement of nozzle hole outlets according to a fourth embodiment;

FIG. 26B is a diagram illustrating an arrangement of sprays according to the fourth embodiment;

FIG. 27A is a diagram illustrating an arrangement of nozzle hole outlets according to a fifth embodiment; and

FIG. 27B is a diagram illustrating an arrangement of sprays according to the fifth embodiment.

### DETAILED DESCRIPTION

To begin with, examples of relevant techniques will be described.

Formation of a homogeneous air-fuel mixture is effective for improving combustion efficiency. In a comparative example, there have been known techniques for spraying an entire space using a plurality of nozzle holes, and techniques for wide diffusion of spray to form a homogeneous air-fuel mixture. For example, a fuel injection valve in the comparative example has a conical tapered nozzle hole with a flow passage expanding from an inlet toward an outlet. A flow is pressed against a wall surface of the tapered nozzle hole to form a liquid film of the fluid, and the tapered shape of the nozzle hole widens an angle of the fluid for injection. Thus, dispersibility of the spray can be improved.

A liquid film wide-angle direction in a tapered nozzle hole is uniquely determined by a suck bottom angle, a nozzle hole angle, and a nozzle hole length. When sprays are arranged such that a longitudinal direction of the sprays from taper nozzle holes are continuous in a circumferential direction of the sprays and surround a space around a valve axis, a gap between sprays adjacent to each other in the circumferential direction becomes narrow, air is less likely to be supplied. As a result, a negative pressure in a space radially inside the spray increases, and the spray is attracted toward the valve axis and contracts. Therefore, the spray cannot be arranged in a targeted direction. Further, when a circumferential interval of the sprays is widened to avoid spray contraction, the sprays are hardly arranged in an entire space.

In contrast to the comparative example, according to a fuel injection valve of the present disclosure, widening an angle of spray from a nozzle hole enables to arrange in an entire space.

A fuel injection valve of the present disclosure includes a nozzle and a needle. The nozzle is centered on a valve axis. The nozzle includes a suck chamber, nozzle holes, and a valve seat. A suck chamber is provided in a bottom of a fuel passage. The nozzle holes penetrate from a nozzle hole inlet formed in a bottom of the suck chamber to a nozzle hole outlet formed in an outer wall of the nozzle, and fuel in the fuel passage is injected outside through the nozzle holes. The valve seat is formed in an annular shape around the suck chamber. The needle is provided inside the nozzle to be reciprocatable in the valve axis. The needle opens and closes the valve seat to switch between injecting and shutting off fuel.

A specific nozzle hole, which is at least one nozzle hole among nozzle holes, satisfies the following requirements.

<1> The nozzle hole outlet has a flat shape with a major axis and a minor axis.

<2> When the specific nozzle hole is projected in a direction of the nozzle hole axis, a cross-sectional length of the nozzle hole outlet is longer than a cross-sectional length of the nozzle hole inlet in a cross section in a major axis direction of the nozzle hole outlet that passes through the nozzle hole axis. The nozzle hole axis is a straight line connecting a center of the nozzle hole inlet and a center of the nozzle hole outlet. <3> a cross-sectional length of the nozzle hole outlet is shorter than a cross-sectional length of the nozzle hole inlet in a cross section of the nozzle hole outlet passing through the nozzle hole axis in a minor axis direction.

<4> An area of the nozzle hole inlet is larger than an area of the nozzle hole outlet.

As a result, in the present disclosure, the fuel injection valve has a function of realizing wide-angle spray only by a shape and arrangement of the specific nozzle hole, and determining a wide-angle direction of the spray by the shape and arrangement. Since an angle of the spray is widened, a circumferential gap between the sprays can be secured. This makes it easier for air to be supplied to a space around the valve axis, so that spray contraction can be avoided, and the arrangement of the spray can be arranged closer to an entire space.

The specific nozzle hole have an area ratio of 1.5 or more. The area ratio is the area of the nozzle hole inlet to the area of the nozzle hole outlet. As a result, the nozzle hole outlet is in a liquid-filling state in an operating state, and a taper angle, a liquid-filling angle and an actual injection angle substantially match each other. Therefore, a stability of wide-angle injection is improved, and the specific nozzle hole can be easily designed. As a result, a spray wide angle can be set by the nozzle hole angle.

Hereinafter, a plurality of embodiments of a fuel injection valve will be described with reference to the drawings. The fuel injection valve of the present embodiment is mounted on an engine such as a gasoline engine, and injects fuel into a combustion chamber of the engine. In the description of the present embodiment, first to fifth embodiments are distinguished only with respect to variations in a nozzle hole outlet arrangement and a spray arrangement, and other matters are commonly explained.

[Overall Configuration of Fuel Injection Valve]

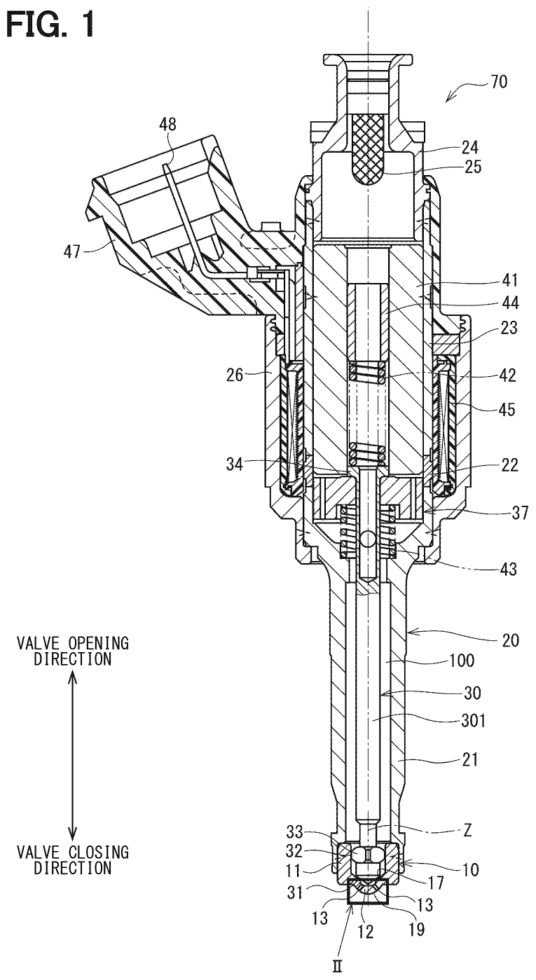

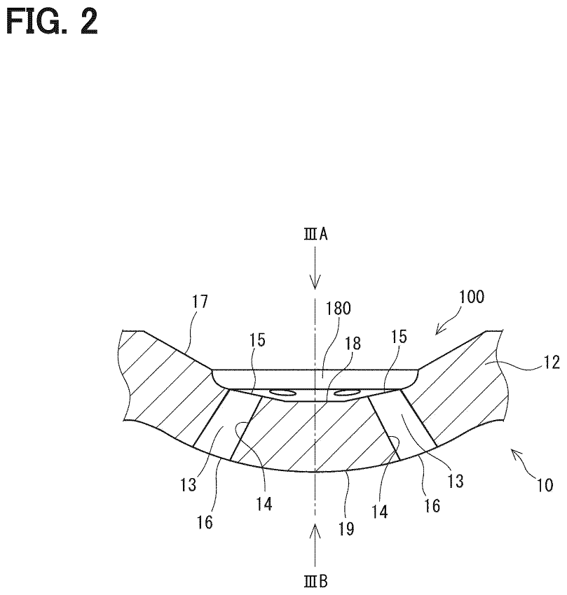

First, an overall configuration of a fuel injection valve 70 will be described with reference to FIGS. 1 and 2. The overall configuration is in common with the prior art of Patent Literature 1, and detailed description thereof will be omitted as appropriate. The fuel injection valve 70 includes a nozzle 10, a housing 20, a needle 30, a movable core 37, a stationary core 41, a coil 45, springs 42, 43 and the like. The movable core 37, the stationary core 41, and the coil 45 function as a driving unit for moving the needle 40 in a valve opening direction and a valve closing direction.

The nozzle 10 includes a nozzle cylinder portion 11, a nozzle bottom portion 12, nozzle holes 13, a valve seat 17, and the like. A center of the nozzle 10 is provided at a center of a valve axis Z. The nozzle cylinder portion 11 is formed in a substantially cylindrical shape. The nozzle cylinder portion 11 forms a fuel passage 100 inside. The nozzle bottom portion 12 closes one end of the nozzle cylinder portion 11. The nozzle holes 13 formed in the nozzle bottom portion 12 inject fuel in the fuel passage 100. The valve seat 17 is provided in an annular shape on a periphery of the nozzle holes 13 on a surface of the nozzle bottom portion 12 on the side of the nozzle cylinder portion 11. The nozzle holes 13 will be described in detail later.

The housing 20 includes a first cylinder member 21, a second cylinder member 22, a third cylinder member 23, an inlet portion 24, and the like. The first cylinder member 21, the second cylinder member 22, and the third cylinder member 23 are all substantially cylindrical members and are coaxially arranged in the order of the first cylinder member 21, the second cylinder member 22, and the third cylinder member 23. The first cylinder member 21, the second cylinder member 22, and the third cylinder member 23 are connected to each other. One end of the inlet portion 24 is connected to an end of the third cylinder member 23, and the other end of the inlet portion 24 is connected to a pipe (not shown). A filter 25 is provided inside the inlet portion 24. The filter 25 traps foreign matter contained in the fuel.

The fuel passage 100 is provided inside the housing 20. The fuel that has flowed in from the inlet portion 24 via the fuel passage 100 and an inside of the nozzle cylinder portion 11 is injected from the nozzle holes 13. A pressure of the fuel in the fuel passage 100 assumed when the fuel injection valve 70 of the present embodiment is used is, for example, about 20 MPa.

The needle 30 is provided so as to reciprocate along the valve axis Z inside the nozzle 10. The needle 30 includes a needle body 301, a seat portion 31, a large diameter portion 32, a flange portion 34, and the like. The needle body 301 has a rod shape. The seat portion 31 is formed at an end portion of the needle body 301 facing the nozzle 10 and can contact the valve seat 17.

The large diameter portion 32 is provided in the vicinity of the seat portion 31 at an end portion of the needle body 301 facing the valve seat 17. An outer diameter of the large diameter portion 32 is set to be larger than an outer diameter of the end portion of the needle body 301 facing the valve seat 17. The large diameter portion 32 is provided such that an outer wall of the large diameter portion 32 slides on an inner wall of the nozzle cylinder portion 11 of the nozzle 10. The fuel can flow through notch portions 33 formed at locations at the outer wall of the large diameter portion 32 in a circumferential direction of the large diameter portion 32. The flange portion 34 protrudes radially outward from the end portion of the needle body 301 opposite to the seat portion 31.

The needle 30 closes the nozzle holes 13 when the seat portion 31 contacts the valve seat 17 and opens the nozzle holes 13 when the seat portion 31 is separated from the valve seat 17. Hereinafter, a direction in which the needle 30 is separated from the valve seat 17 is referred to as a valve opening direction, and a direction in which the needle 30 comes into contact with the valve seat 17 is referred to as a valve closing direction.

The movable core 37 has a substantially cylindrical shape, and is made from a magnetic material such as ferritic stainless steel subjected to magnetic stabilization treatment. The movable core 37 is provided inside the first cylinder member 21 and the second cylinder member 22 of the housing 20. The movable core 37 can move relative to the needle body 301 in an axial direction.

The stationary core 41 has a substantially cylindrical shape, and is made from a magnetic material such as ferritic stainless steel subjected to magnetic stabilization treatment. The stationary core 41 is provided inside the second cylinder member 22 and the third cylinder member 23 of the housing 20. The stationary core 41 is arranged at a position facing the inlet portion 24 respect to the movable core 37.

A cylindrical adjusting pipe 54 is press-fitted inside the stationary core 41. A spring 42 is, for example, a coil spring, and is provided between the adjusting pipe 54 inside the stationary core 41 and the flange portion 34 of the needle 30. The spring 42 urges the movable core 37 together with the needle 30 in the valve closing direction.

The coil 45 is provided in a substantially cylindrical shape, and is provided so as to surround an outer side of the housing 20, particularly, the second cylinder member 22 and the third cylinder member 23 of the housing 20 in a radial direction. A tubular holder 26 is provided outside the coil 45 in the radial direction so as to cover the coil 45.

When the coil 45 is energized from an external control device via a terminal 48 of a connector portion 47, the movable core 37, the first cylinder member 21, the holder 26, the third cylinder member 23 and the stationary core 41 form a magnetic circuit except for the second cylinder member 22, which is a magnetic throttle portion. Thereby, a magnetic attraction force is generated between the stationary core 41 and the movable core 37, and the movable core 37 is attracted toward the stationary core 41 together with the needle 30. Accordingly, the needle 30 moves in the valve opening direction, and the seat portion 31 is separated from the valve seat 17. As a result, the nozzle hole 13 is opened, and the fuel is injected from the nozzle hole 13. The coil 45 attracts the movable core 37 toward the stationary core 41 when energized, and moves the needle 30 in the valve opening direction.

When the energization of the coil 45 is stopped while the movable core 37 is attracted toward the stationary core 41, the needle 30 and the movable core 37 are urged toward the valve seat 17 by an urging force of the spring 42. As a result, the needle 30 moves in the valve closing direction, and the seat portion 31 comes into contact with the valve seat 17. As a result, the nozzle holes 13 are closed.

The spring 43 is, for example, a coil spring, and biases the movable core 37 toward the stationary core 41, that is, in the valve opening direction. An urging force of the spring 43 is smaller than the urging force of the spring 42. Therefore, when the coil 45 is not energized, the seat portion 31 of the needle 30 is pressed against the valve seat 17 by the spring 42, and the nozzle holes 13 are closed.

The fuel flowing from the inlet portion 24 passes through an inside of the stationary core 41 and the adjusting pipe 54, the fuel passage 100 between the needle 30 and an inner wall of the housing 20, and the inner wall of the nozzle cylinder portion 11, and then the fuel flows into the nozzle holes 13. When the fuel injection valve 70 is actuated, surroundings of the movable core 37 and the needle 30 are filled with fuel. As a result, the movable core 37 and the needle 30 can smoothly reciprocate in the axial direction inside the housing 20.

FIG. 2 shows an axial cross-section of the nozzle holes 13 corresponding to an enlarged cross-section of section II in FIG. 1. The needle 30 is not shown in FIG. 2. The nozzle bottom portion 12 of the nozzle 10 has a suck chamber 180, the nozzle holes 13 and the valve seat 17. The number of the nozzle holes is for example six.

The suck chamber 180 is provided at a bottom of the fuel passage 100. The nozzle holes 13 penetrate from a nozzle hole inlet 15 formed in a bottom surface 18 of the suck chamber 180 to a nozzle hole outlet 16 formed at an outer wall 19 of the nozzle. The fuel in the fuel passage 100 is injected through the nozzle holes 13. A wall surface 14 of each of the nozzle holes 13 connects the nozzle hole inlet 15 and the nozzle hole outlet 16. The valve seat 17 is formed in an annular shape around the suck chamber 180. The valve seat 17 is formed in a tapered shape so as to approach the valve axis Z from the nozzle cylinder portion 11 toward the suck chamber 180.

[Structure of Specific Nozzle Hole]

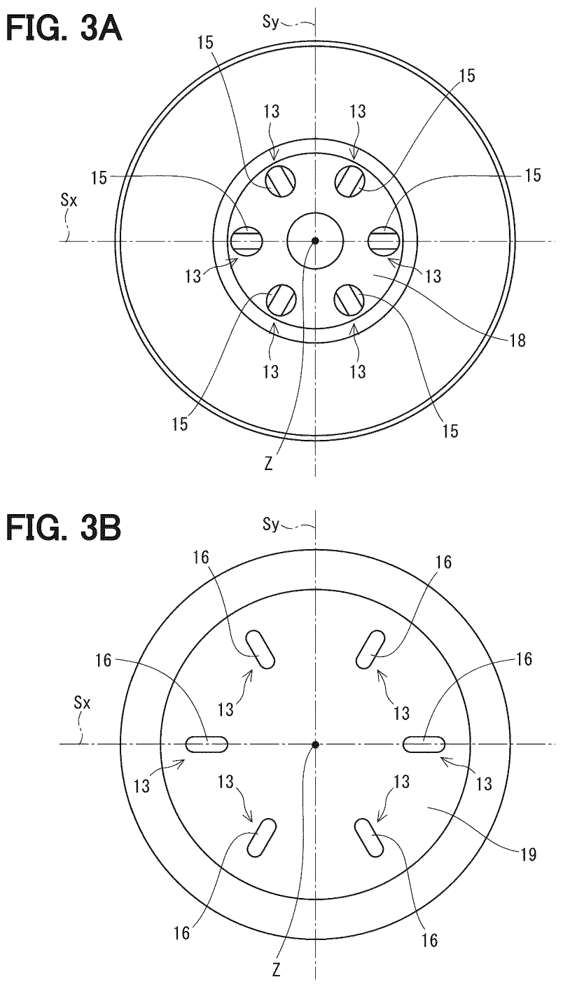

Among the nozzle holes 13, one or more nozzle holes 13 having a shape that satisfies preferable conditions in the present embodiment are defined as “specific nozzle holes”. In the present embodiment, a configuration in which all of the nozzle holes 13 are specific nozzle holes 13 will be described. However, the configuration is not limited to such a configuration, and a configuration in which a nozzle hole other than the specific nozzle hole 13 is included in the nozzle holes may be employed. Next, details of a shape of the specific nozzle holes 13 will be described with reference to FIGS. 3A to 6.

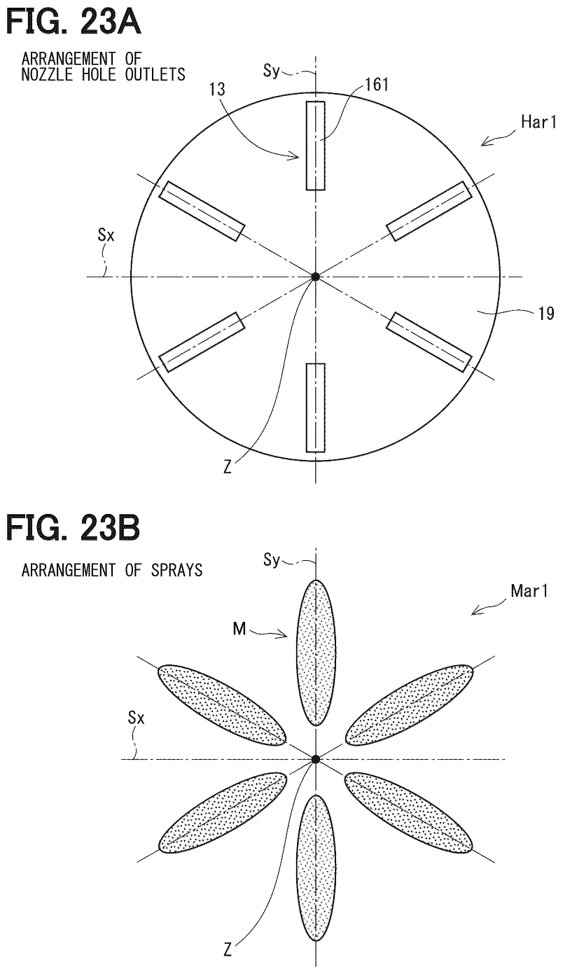

FIG. 3A shows an arrangement of nozzle hole inlets 15 viewed from the bottom surface 18 of the suck chamber 180 in FIG. 2. FIG. 3B shows an arrangement of the nozzle hole outlets 16 viewed from the outer wall 19 in FIG. 2. In the arrangement, six specific nozzle holes 13 are arranged radially around the valve axis Z. For convenience, in FIGS. 3A and 3B, a plane including the valve axis Z and represented by a one-dot chain line extending in a left-right direction is defined as a reference plane Sx, and a plane including the valve axis Z and represented by a one-dot chain line extending in a up-down direction is referred to as a symmetry plane Sy. The reference plane Sx and the symmetry plane Sy are used in the description of arrangement variations of the nozzle holes 13 described later with reference to FIGS. 23A to 27B.

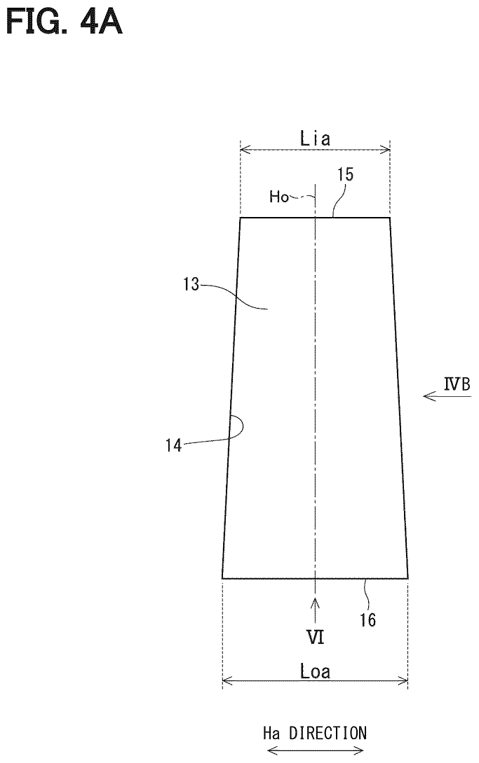

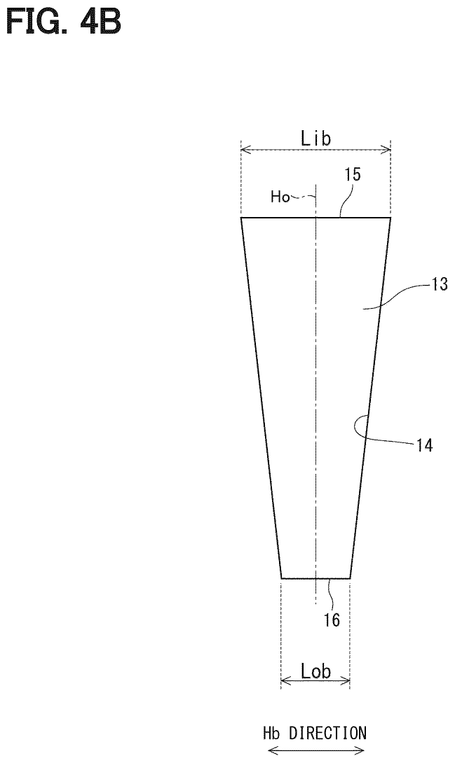

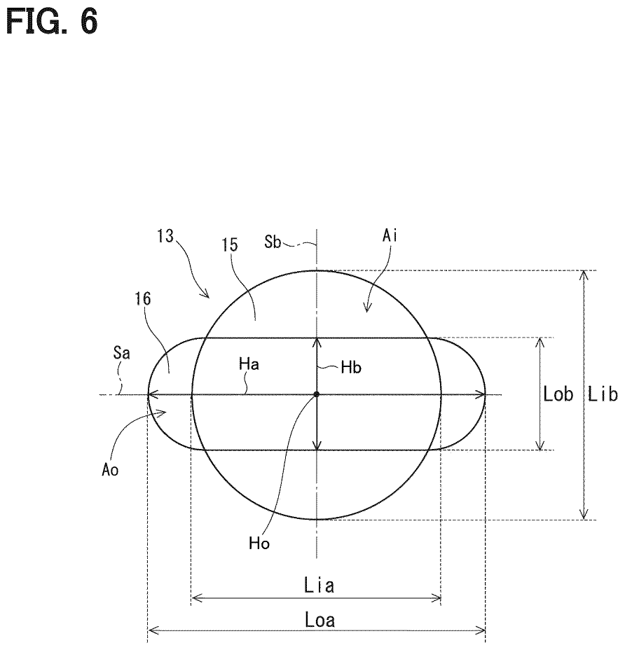

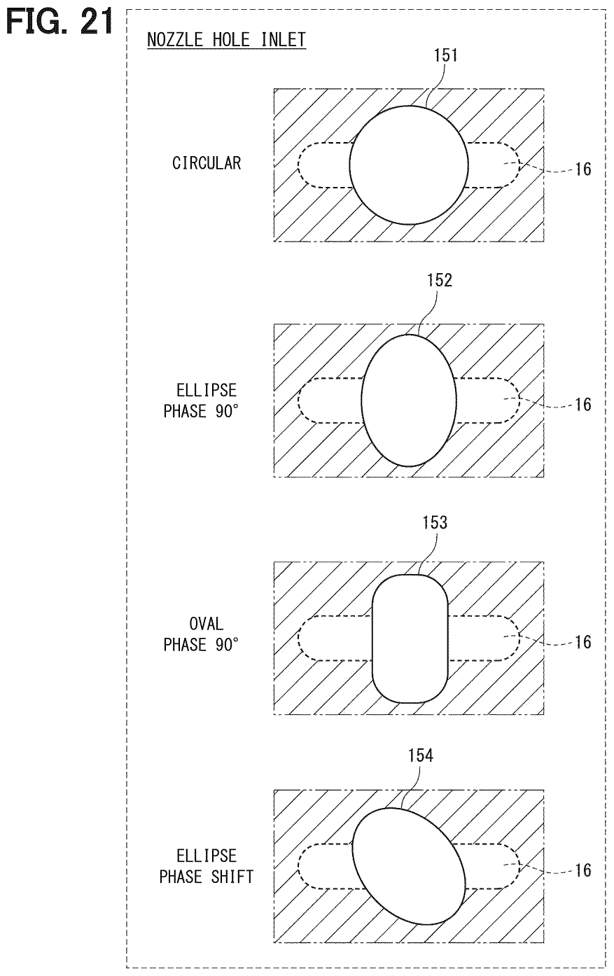

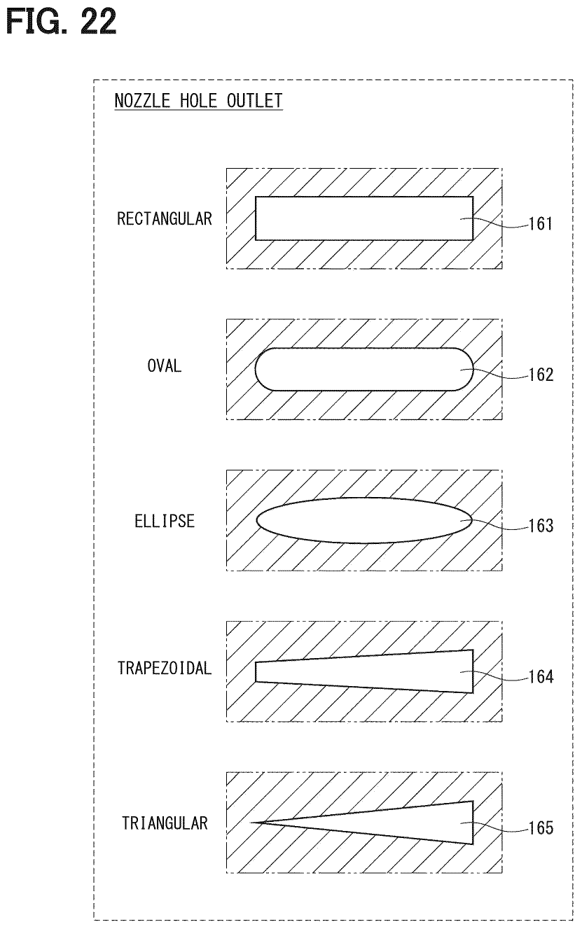

As shown in FIGS. 4A to 6, the specific nozzle hole 13 satisfies the following requirements <1> to <4>. In the present embodiment, all of the six nozzle holes 13 are specific nozzle holes, then hereinafter, “nozzle holes 13” means specific nozzle holes unless otherwise specified. Further, typical examples of a shape of the specific nozzle holes 13 illustrated in FIGS. 4A to 6 are referred to as “basic examples.” FIGS. 4A to 6 schematically show only the nozzle hole 13 assuming that there is no substance around the nozzle hole 13. A straight line connecting a center of the nozzle hole inlet 15 and a center of the nozzle hole outlet 16 of each specific nozzle hole 13 is defined as a nozzle hole axis Ho.

<1> The nozzle hole outlet 16 has a flat shape with a major axis Ha and a minor axis Hb. A shape of the nozzle hole outlet 16 of the basic examples is oval and corresponds to the nozzle hole outlet 162 in FIG. 22. Further, a shape of the nozzle hole inlet 15 in the basic examples is circular. Other shape variations of the nozzle hole inlet 15 and the nozzle hole outlet 16 will be described later with reference to FIGS. 21 and 22.

<2> As shown in FIG. 6, when the specific nozzle hole 13 is projected in a direction of the nozzle hole axis Ho, a cross-sectional length Loa of the nozzle hole outlet 16 is longer than a cross-sectional length Lia of the nozzle hole inlet 15 in a cross section Sa in the major axis direction of the nozzle hole outlet 16 that passes through the nozzle hole axis Ho. <3> a cross-sectional length Lob of the nozzle hole outlet 16 is shorter than a cross-sectional length Lib of the nozzle hole inlet 15 in a cross section Sb of the nozzle hole outlet 16 passing through the nozzle hole axis Ho in a minor axis direction.

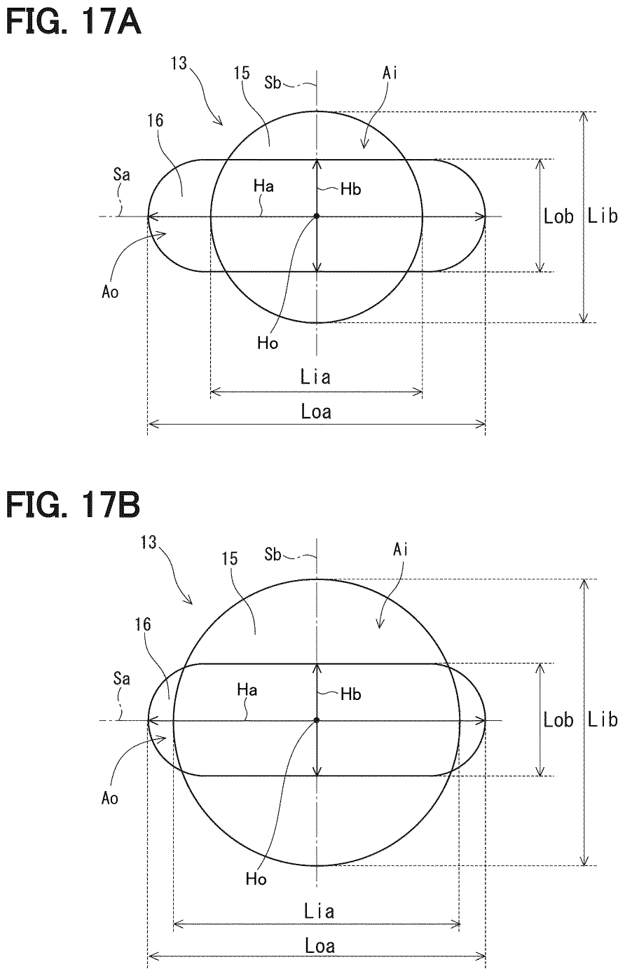

Requirements <2> and <3> compare the cross-sectional lengths of the nozzle hole inlet 15 and the nozzle hole outlet 16 at least for cross sections Sa and Sb passing through the nozzle hole axis Ho. Also, the same relationship can be extended to a cross section parallel to the cross section Sa in the major axis direction in an overlapping region between the nozzle hole inlet 15 and the nozzle hole outlet 16. The same relationship also can be extended to a cross section parallel to the cross section Sb in the minor axis direction. Therefore, requirements <2ex> and <3ex>, which are extensions of requirements <2> and <3>, are expressed as follows.

<2ex> When the specific nozzle hole 13 is projected in the direction of the nozzle hole axis Ho, a cross-sectional length of the nozzle hole outlet 16 is longer than the cross-sectional length of the nozzle hole inlet 15 in all cross section in the major axis direction of the nozzle hole outlet 16 in the overlapping region between the nozzle hole inlet 15 and the nozzle hole outlet 16. And <3ex> the cross-sectional length of the nozzle hole outlet 16 is shorter than the cross-sectional length of the nozzle hole inlet 15 in all cross section in the minor axis direction of the nozzle hole outlet 16 in the overlapping region between the nozzle hole inlet 15 and the nozzle hole outlet 16.

<4> An area Ai of the nozzle hole inlet 15 is larger than an area Ao of the nozzle hole outlet 16. In the other ward, the specific nozzle holes 13 have an area ratio (=Ai/Ao) of more than 1.0. The area ratio is the area Ai of the nozzle hole inlet 15 to the area Ao of the nozzle hole outlet 16. The area ratio may be 1.5 or more. Bases for this will be described later with reference to FIGS. 17A to 20.

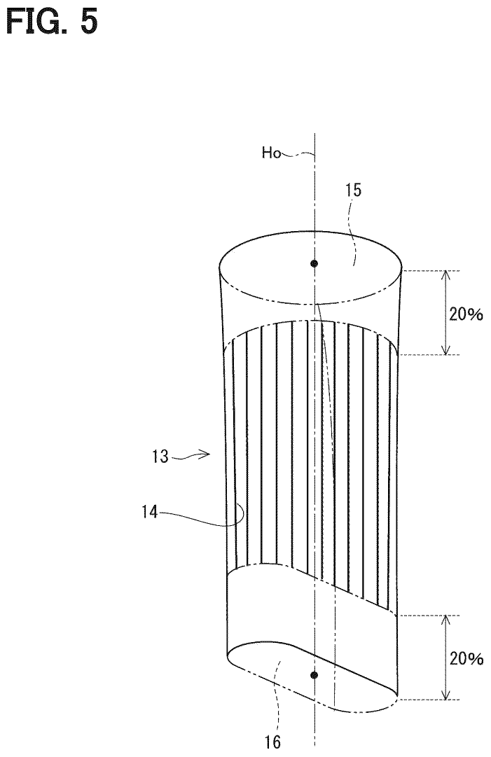

Here, referring to FIG. 5, shape characteristics of the wall surface 14 of the nozzle holes 13 resulting from a manufacturing method of the specific nozzle holes 13 will be supplemented. The specific nozzle holes 13 of the present embodiment are formed by laser processing. At this time, due to the characteristics of the laser processing, the wall surface 14 of the nozzle hole 13 is formed with substantially straight lines in the cross section Sa of the nozzle hole outlet 16 and the cross section Sb of the nozzle hole outlet 16 in an entire range of the nozzle hole length from the nozzle hole inlet 15 to the nozzle hole outlet 16. It is noted that, “substantially straight lines” mean a linear shape recognized as a substantially straight line in light of manufacturing common sense in the relevant technical field.

However, the vicinity of the nozzle hole inlet 15 and a vicinity of the nozzle hole outlet 16 may be pre-drilled or post-processed by processing other than the laser processing. Its range in the vicinity of the nozzle hole inlet 15 and the nozzle hole outlet 16 is presumed to be within 20% of the nozzle hole length on the nozzle hole inlet 15 and the nozzle hole outlet 16, based on common manufacturing knowledge in the relevant technical field. In consideration of this point, the wall surface 14 of the nozzle hole 13 is formed with substantially straight lines in the cross section Sa in the major axis direction of the nozzle hole outlet 16 and the cross section Sb of the nozzle hole outlet 16 in a range that is at least “a range excluding 20% from the nozzle hole inlet and 20% from the nozzle hole outlet side” of the nozzle hole length from the nozzle hole inlet 15 to the nozzle hole outlet 16.

### Issue of this Embodiment

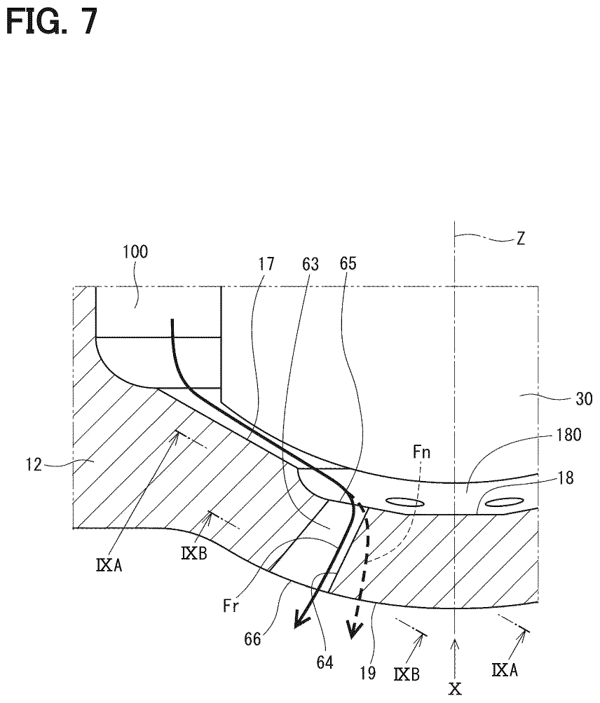

Next, with reference to FIGS. 7 to 16, an issue to be focused on in the present embodiment and a concept for solving the issue will be described. FIGS. 7 to 15 show, as comparative examples, configurations of tapered nozzle holes in which an inner diameter of a nozzle hole increases from a nozzle hole inlet toward a nozzle hole outlet. In order to distinguish from the specific nozzle holes 13 of the present embodiment, the reference numeral of tapered nozzle holes of the comparative example is set to “63”. In addition, reference numerals for a wall surface of the tapered nozzle holes, the nozzle hole inlet, and the nozzle hole outlet in the comparative examples are “64,” “65,” and “66,” respectively. Note that a nozzle bottom portion 12, a bottom surface 18 of a suck chamber, an outer wall 19 of the nozzle share the reference numerals of the present embodiment.

1. Wide-Angle Mechanism of Tapered Nozzle Hole

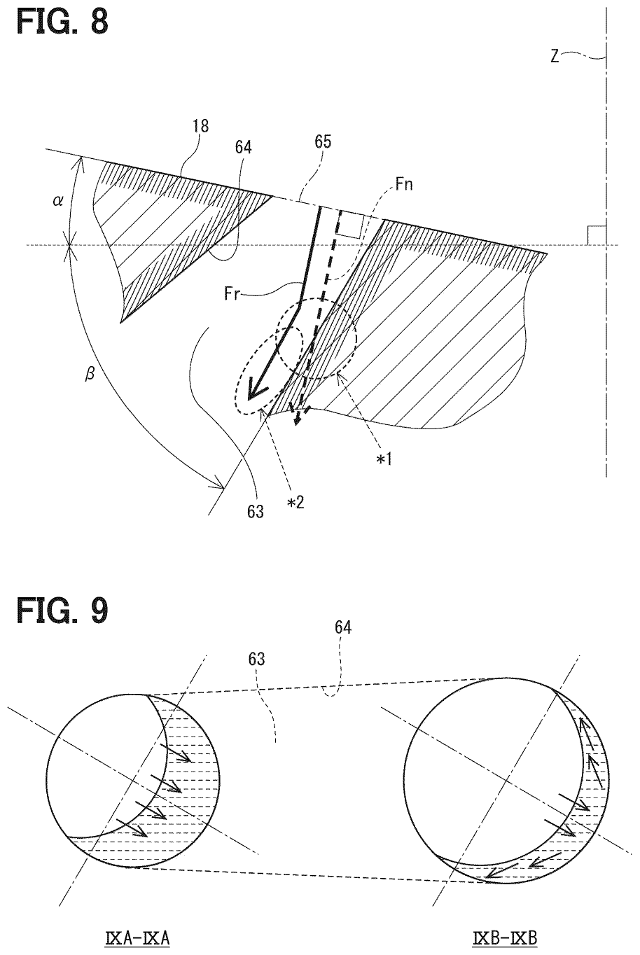

Next, the wide-angle mechanism of tapered nozzle hole will be described with reference to FIGS. 7 to 9. FIG. 8 shows definitions of a suck bottom angle α and a nozzle hole angle β. The suck bottom angle α is an angle of the bottom surface 18 of the suck chamber with respect to a plane P perpendicular to the valve axis Z. The nozzle hole angle β is an angle of an inner wall of the nozzle hole 63, which is on the side of the valve axis Z, with respect to the plane P. An angle (=90°−β) of the inner wall of the nozzle hole 63, which is on the side of the valve axis Z, with respect to the valve axis Z may be defined as the nozzle hole angle.

Dashed arrows in FIGS. 7 and 8 indicate an original flow Fn, and solid arrows indicate the actual flow Fr. Originally, fuel tends to flow in a vertical direction to the bottom surface 18, but since the wall surface 64 is provided in a flow direction at a part (*1) in FIG. 8, the fuel flows along the wall surface 64 while being pressed against the wall surface 64. At this time, a collision with the wall surface 64 spreads the fuel, and an angle of a spray widens at a part (*2) in FIG. 8.

FIG. 9 shows a flow direction of a fuel in an IXA-IXA cross section and an IXB-IXB cross section of FIG. 7. An inner diameter of the nozzle hole 63 increases from the IXA-IXA cross section toward the IXB-IXB cross section. At a position of the IXA-IXA cross section, the fuel is pressed against the wall surface 64 and transformed into a thin film. At a position of the IXB-IXB cross section, the fuel angle widens due to the taper.

An angle widening direction is determined by the suck bottom angle α, the nozzle hole angle β, and the nozzle hole length. Regarding the nozzle hole length, when the nozzle hole length is extremely short relative to a nozzle hole diameter, there is a possibility that the fuel will reach the nozzle hole outlet 16 before the direction of the fuel flow changes. On the other hand, when the nozzle hole length is long enough to change the direction of the fuel flow, the angle widening direction is not affected beyond that point. Therefore, it may be considered that the angle widening direction is almost uniquely determined by the suck bottom angle α and the nozzle hole angle β.

2. Wide-Angle Nozzle Hole Shape of Tapered Nozzle Hole

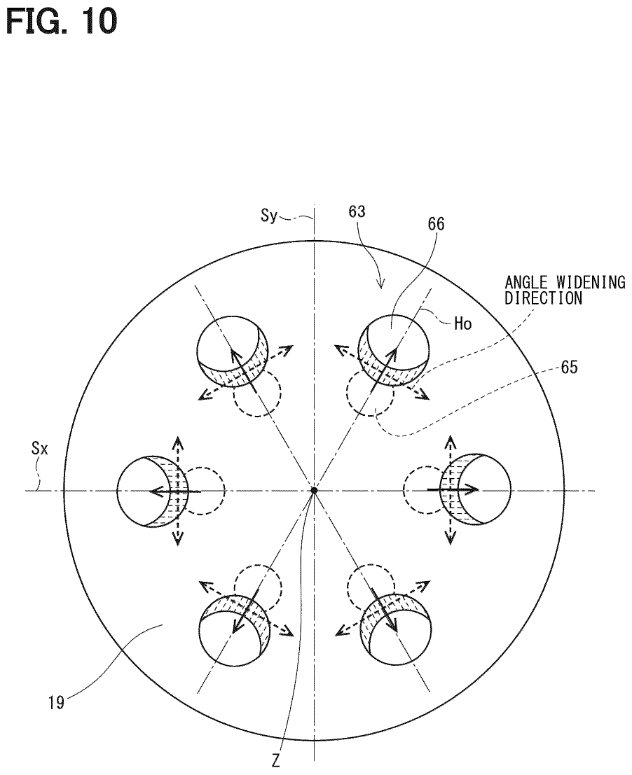

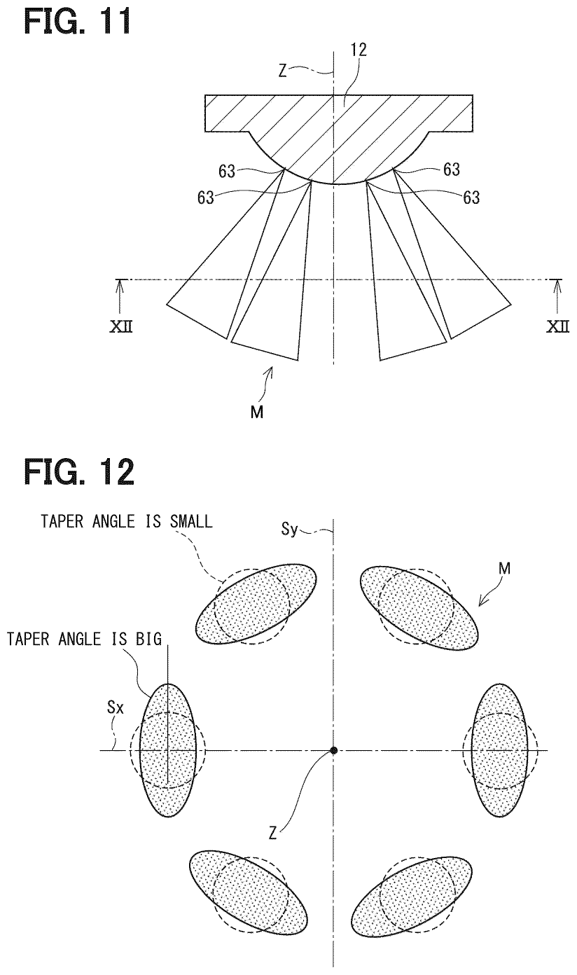

Next, the wide-angle nozzle hole shape of the tapered nozzle holes will be described with reference to FIGS. 10 to 12. FIG. 10 shows an example in which multiple (for example, six of) tapered nozzle holes 63 are arranged radially with respect to the valve axis Z. In the figure, the reference numeral “63” for the tapered nozzle hole, the symbol “M” for the spray, or the like is indicated only at one location, and the description of the other locations is omitted. In FIG. 10, a solid line arrow indicates the direction from the nozzle hole inlet 65 to the nozzle hole outlet 66 along the nozzle hole axis Ho, and a broken double-headed arrow indicates a direction of the angle widening direction of the fuel. FIG. 11 shows a side view of the spray M, and FIG. 12 shows a XII-XII section of FIG. 11. As indicated by the dashed line in FIG. 12, the cross section of the spray when a taper angle of the nozzle hole is small is substantially circular. When the taper angle is large, the cross section of the spray becomes elliptical due to the widening of the angle, and sprays are arranged to surround a space around the valve axis Z.

3. Issue in Wide-Angle Spray of Tapered Nozzle Hole

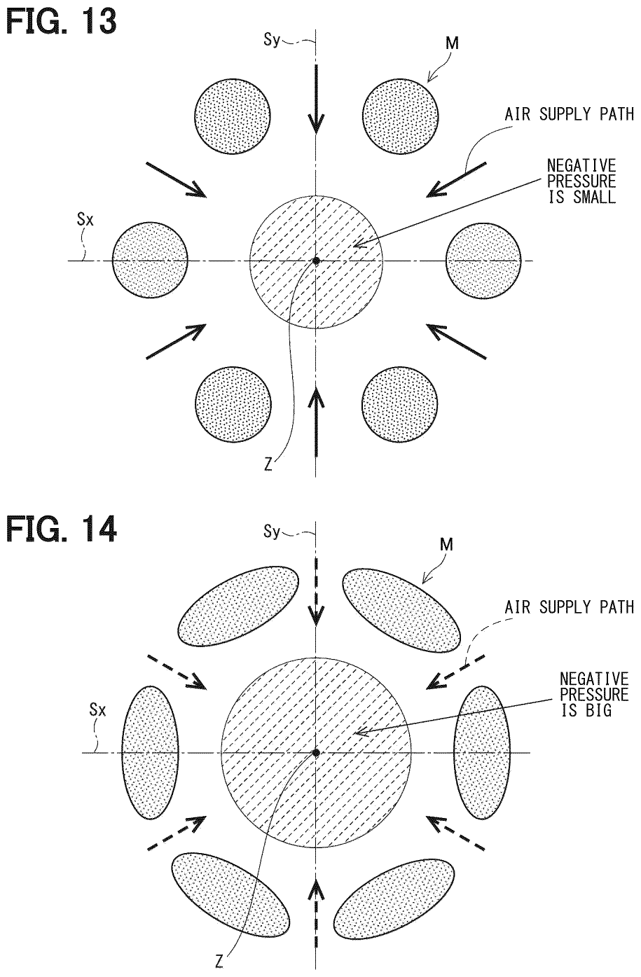

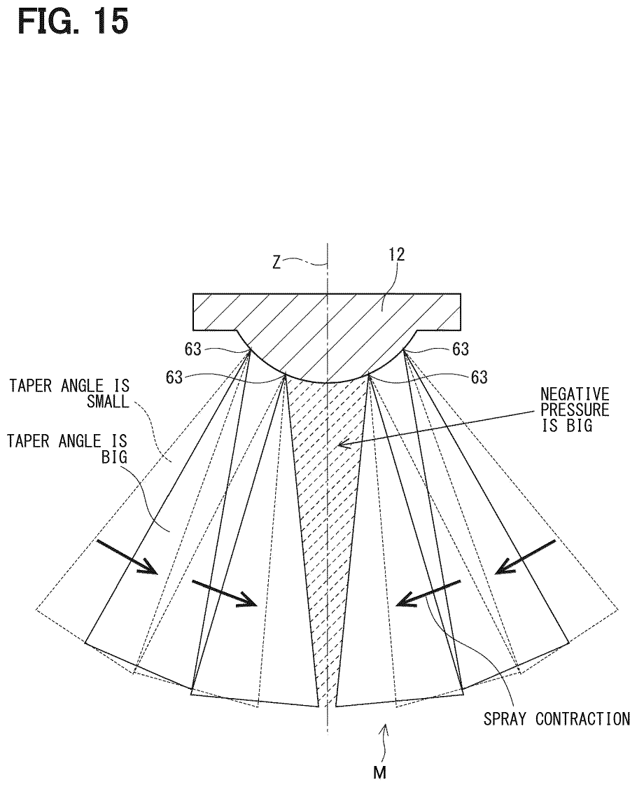

Next, the wide-angle spray will be described with reference to FIGS. 13 to 15. Hereinafter, a space around the valve axis Z formed radially inward of the spray is referred to as an “inner space”, and a space radially outward of the spray is referred to as an “outer space”. As shown in FIG. 13 based on FIG. 12, when the taper angle is small, a gap communicating with the inner space and the outer space is formed between sprays that are adjacent in the circumferential direction. Air is discharged from the inner space by injection, however air is introduced from the outer space to the inner space through this gap. That is, since this gap functions as an air supply path, a negative pressure generated in the inner space is small. Therefore, as shown in FIG. 15, the spray spreads away from the valve axis Z when the taper angle is small.

Contrary to this, as shown in FIG. 14, when the taper angle is large, since the angle of the spray is widened, positions of sprays are continuous in the circumferential direction and surrounds the inner space. As a result, the air supply path between the sprays adjacent to each other in the circumferential direction is narrowed, to cause air to be hardly supplied to the inner space. Dashed arrows in FIG. 14 indicates that the air supply channel is narrow. Therefore, the negative pressure generated in the inner space increases, and the spray is attracted to the valve axis Z and contracts as indicated by arrows in FIG. 15. Therefore, the spray cannot be arranged in a targeted direction. Further, when a circumferential interval of the sprays is widened to avoid spray contraction, the sprays are hardly arranged in an entire space.

4. Concept of Issue Solving

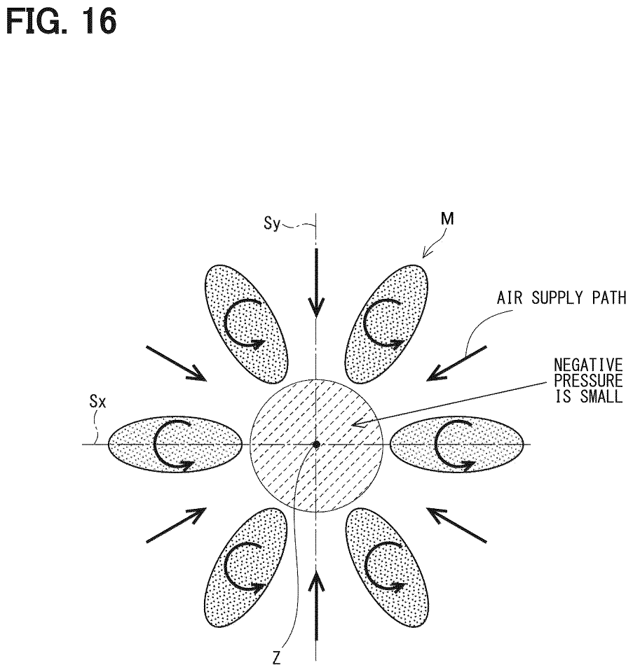

The concept of the present embodiment for solving the issues of the comparative examples as described above will be described with reference to FIG. 16. In the present embodiment, a spray wide-angle direction is rotated by 90° with respect to the comparative examples so that the major axis of the spray is directed radially with respect to the valve axis Z. Thereby, an air supply path is ensured between sprays adjacent to each other in the circumferential direction. By increasing a degree of freedom in the spray wide-angle direction in this way, it is possible to achieve both widening of the spray angle and securing of the air supply path. That is, the structure is such that the spray wide-angle direction is determined only by a spray rotation direction without using a flow.

Based on this idea, a nozzle hole shape and nozzle hole arrangement of the specific nozzle holes 13 illustrated in FIGS. 3A to 6 is developed. The fuel injection valve 70 of the present embodiment has a function of realizing widening of the spray angle only by the shape and arrangement of the specific nozzle holes 13 and determining the spray wide-angle direction. Air can be supplied to the space around the valve axis Z by securing the gap between the wide-angle sprays in the circumferential direction. As a result, the sprays avoid contraction, and the spray arrangement allows to be closer to an overall space.

[Setting the Area Ratio Between the Nozzle Hole Inlet and the Nozzle Hole Outlet]

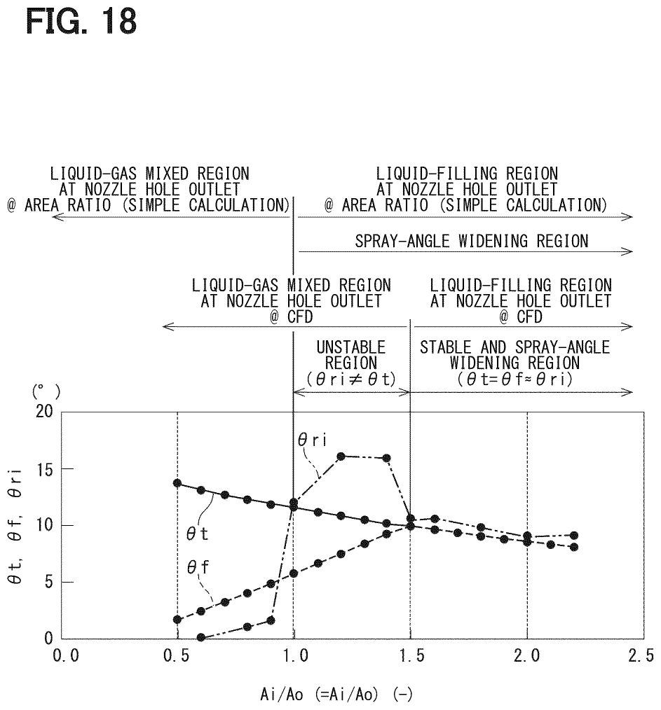

Next, with reference to FIGS. 17A to 20, a setting of the area ratio between the nozzle hole inlet 15 and the nozzle hole outlet 16 in the specific nozzle holes 13 will be described. Based on FIG. 6, which is a projection view in the direction of the nozzle hole axis Ho, FIG. 17A shows an example with a small area ratio, and FIG. 17B shows an example with a large area ratio. More specifically, the area Ao of the nozzle hole outlet 16 is kept constant, and only the area Ai of the nozzle hole inlet 15 is changed. FIG. 18 shows a relationship between the area ratio and a taper angle θt, a liquid-filling angle θf, and an actual injection angle θri with respect to the area ratio of 0.5 to 2.2.

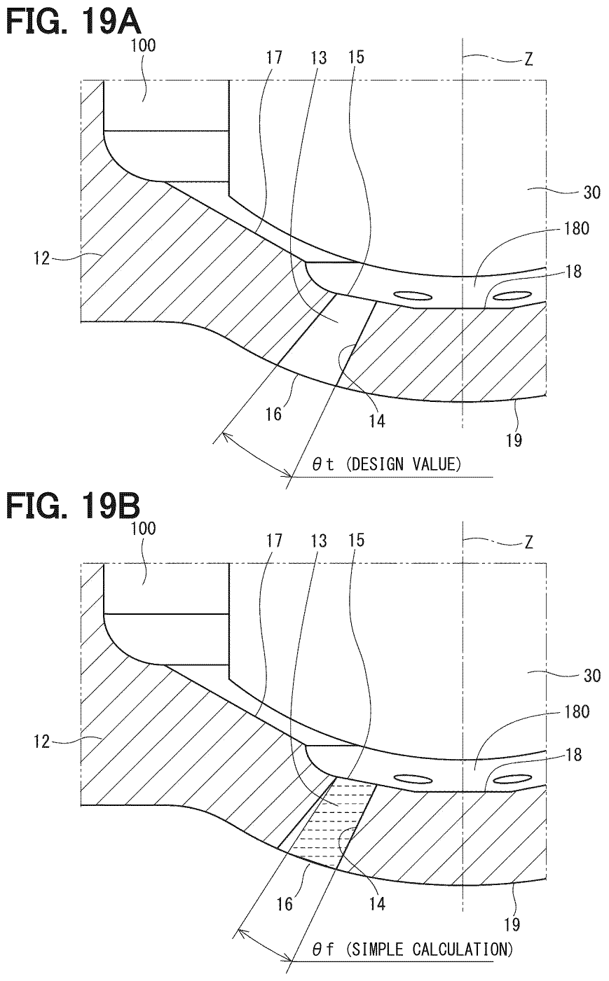

As shown in FIG. 19A, the taper angle θt is a design value of an angle of the nozzle holes 13 in a cross section in the direction of the major axis Ha. As shown in FIG. 19B, the liquid-filling angle θf is a ridge line angle when a liquid is drawn toward an inner wall on the valve axis Z, assuming that an outlet liquid area is equal to an inlet liquid area. The liquid-filling angle θf is calculated by a simple calculation. When the nozzle hole 13 is full with the liquid, the liquid-filling angle θf matches the taper angle θt. That is, the liquid-filling angle θf is equal to or less than the taper angle θt.

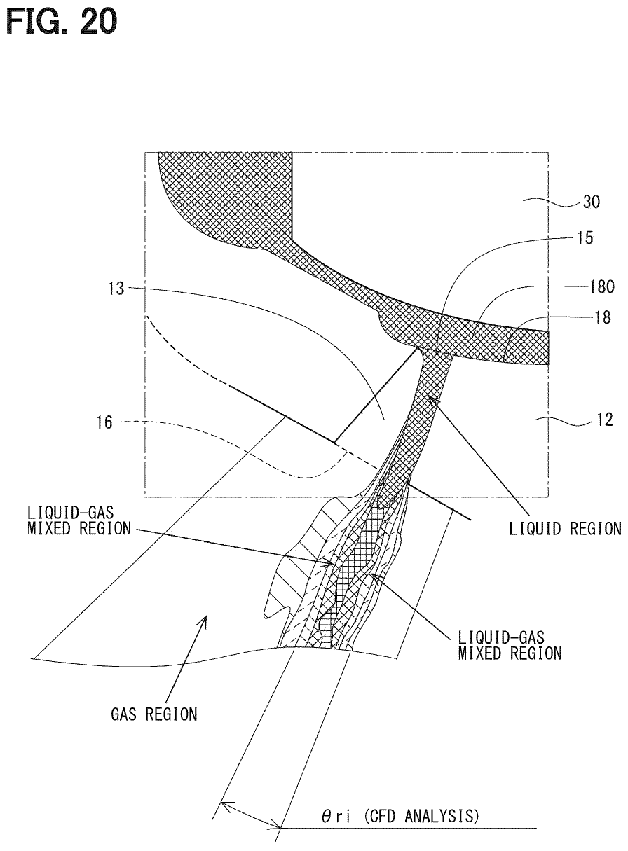

An area enclosed by a double-dashed line in FIGS. 19A and 19B is an CFD (i.e., Computer Fluid Dynamics) analysis area in FIG. 20. The actual injection angle θri is an angle formed by boundary lines between a liquid-only region and a liquid-gas mixed region obtained from the CFD analysis results illustrated in FIG. 20. In FIG. 20, a densely hatched portion is the liquid region, a white portion is a gas region, and a sparsely hatched portion is the liquid-gas mixed region.

As shown in FIG. 18, the taper angle θt decreases as the area ratio increases. When the area ratio is less than 1.5, the liquid-filling angle θf increases as the area ratio increases, and when the area ratio is 1.5, the liquid-filling angle θf is equal to the taper angle θt. When the area ratio is 1.5 or more, the liquid-filling angle θf decreases together with the taper angle θt as the area ratio increases.

The actual injection angle θri by CFD analysis rapidly increases from a value near 0° to 10° or more when the area ratio is 0.9 to 1.0, and reaches a maximum value when the area ratio is 1.0 to 1.5. When the area ratio is 1.5 or more, the actual injection angle θri decreases in substantially the same manner as the taper angle θt as the area ratio increases.

From the above, based on the area ratio by simple calculation, as a boundary is the area ratio of 1.0, the range where the area ratio is 1.0 or less is the liquid-gas mixing region at the nozzle hole outlet, and the range where the area ratio is greater than 1.0 is a liquid-filling region at the nozzle hole outlet. The liquid-filling region at the nozzle hole outlet is a spray-angle widening region. That is, widening of the spray angle is realized in a range in which the area Ai of the nozzle hole inlet 15 is larger than the area Ao of the nozzle hole outlet 16.

Also, based on the CFD analysis, as a boundary with the area ratio of 1.5, a range where the area ratio is less than 1.5 is liquid-gas mixing region of the nozzle hole outlet, and a range where the area ratio is 1.5 or more is the liquid-filling region of the nozzle hole outlet. In a range where the area ratio is greater than 1.0 and less than 1.5, the actual injection angle θri differs from the taper angle θt, which is an unstable region. On the other hand, in a range where the area ratio is 1.5 or more, the taper angle θt and the liquid-filling angle θf are equal, and the taper angle θt and the actual injection angle θri are also substantially equal. As a result, the range where the area ratio is 1.5 or more is a stable and spray-angle widening region.

In the stable and spray-angle widening region, there is a moment when the nozzle hole outlet 16 becomes a liquid-filling state in an operating state. In addition, wide-angle injection stability is improved, and design easiness is improved. Therefore, an angle of widening spray can be set by the suck bottom angle α and the nozzle hole angle β. The same effect can be obtained even if the area ratio is larger than the maximum area ratio of 2.2 shown in FIG. 18, and an upper limit of the area ratio need not be considered. However, if the area Ao of the nozzle hole outlet 16 becomes extremely small, the required injection amount cannot be injected. Therefore, the area Ai of the nozzle hole inlet 15 may be determined so that the area ratio is 1.5 or more after ensuring that the area Ao of the nozzle hole outlet is in accordance with the required injection volume.

[Variations of Shapes of Nozzle Hole Inlet and Nozzle Hole Outlet]

The nozzle hole inlet 15 in a basic example illustrated in FIGS. 4A to 6 has a circular shape, and the nozzle hole outlet 16 has a flat shape and an oval shape. FIG. 21 shows variations of shapes of the nozzle hole inlet including basic examples, and FIG. 22 shows variations of shapes of the nozzle hole outlet. These shape variations may be appropriately selected in consideration of spray characteristics, manufacturing processes, and the like. Moreover, many shapes of the nozzle hole inlet and nozzle hole outlet may be mixed in the one fuel injection valve.

A first from a top of FIG. 21, a circular nozzle hole inlet 151 is shown as a shape of the nozzle hole inlet of the basic example. By circular, a degree of freedom of a layout on the nozzle hole inlet is improved. A second from the top of FIG. 21, an elliptical nozzle hole inlet 152 is shown. A phase of the nozzle hole inlet 152 is shifted from the major axis of the nozzle hole outlet 16 by 90°. A third from the top of FIG. 21, an oval nozzle hole inlet 153 is shown. A phase of the nozzle hole inlet 153 is shifted from the major axis of the nozzle hole outlet 16 by 90°. A fourth from the top of FIG. 21, the elliptical nozzle hole inlet 154 is shown. A phase of the nozzle hole inlet 154 is shifted from the major axis of the nozzle hole outlet 16 by an angle between 0° and

A first from a top of FIG. 22, a rectangular nozzle hole outlet 161 is shown. A second from the top, an oblong nozzle hole outlet 162 is shown as a base example of a shape of the nozzle hole outlet. The oblong nozzle hole is also called as a track nozzle hole. A third from the top shows an elliptical nozzle hole outlet 163, a fourth shows a trapezoidal nozzle hole outlet 164, and a fifth shows a triangular nozzle hole outlet 165. It is assumed that a longer base of the trapezoidal nozzle hole outlet 164 and a base (ie, right in the FIG. 22) of the triangular nozzle hole outlet 165 is located primarily radially outward.

Variations of Nozzle Hole Outlet Arrangement and Spray Arrangement

Next, with reference to FIGS. 23A to 27B, variations of the nozzle hole outlet arrangement and spray arrangement will be described as first to fifth embodiments. In each embodiment, substantially the same components are denoted by the same reference numerals and description thereof is omitted. FIGS. 23A, 24A, 25A, 26A and 27A show nozzle hole outlet arrangements and FIGS. 23B, 24B, 25B, 26B and 27B show the corresponding spray arrangements. A reference numeral “13” for the specific nozzle hole and a reference numeral “M” for the spray are described only in one place, and the description of the other places is omitted.

Each embodiment is selected according to an engine mounting method of the fuel injection valve 70, a target spray size, and the like. A method in which the fuel injection valve 70 is mounted in a middle area of a cylinder head is called a center mounting type. This method is shown in FIG. 11 of Patent Literature 1. A method in which the fuel injection valve 70 is mounted on the cylinder block on facing a combustion chamber to be inclined is called a side mounting type. This method is shown in FIG. 2 of Patent Literature 1.

As shown in FIGS. 23A, 24A, and 25A, in the first, second, and third embodiments, six nozzle hole outlets are arranged symmetrically about the valve axis Z. Arrangements of these nozzle hole outlets are suitable for the center-mounted type of the fuel injection valve because the fuel is injected radially from a center part. In particular, in the arrangements Har1, Har2 of the nozzle hole outlets of the first and second embodiments, major axes of the nozzle hole outlets 161 and 164 of all the nozzle holes 13 are arranged radially with respect to the valve axis Z. Also, the arrangements Har1, Har2 of the nozzle hole outlet are symmetrical with respect to the symmetry plane Sy.

In the arrangements Har1 of the nozzle hole outlet of the first embodiment, rectangular nozzle hole outlets 161 are arranged radially. The rectangular nozzle hole outlet 161 may be replaced with the oblong nozzle hole outlet 162 or the elliptical nozzle hole outlet 163. The same applies to the following embodiments. Correspondingly, a radial spray arrangement Mar1 is formed as shown in FIG. 23B. In this spray arrangement Mar1, since a gap through which air is introduced is secured between the sprays adjacent in the circumferential direction, spray contraction can be avoided, and the spray can be arranged in a targeted direction.

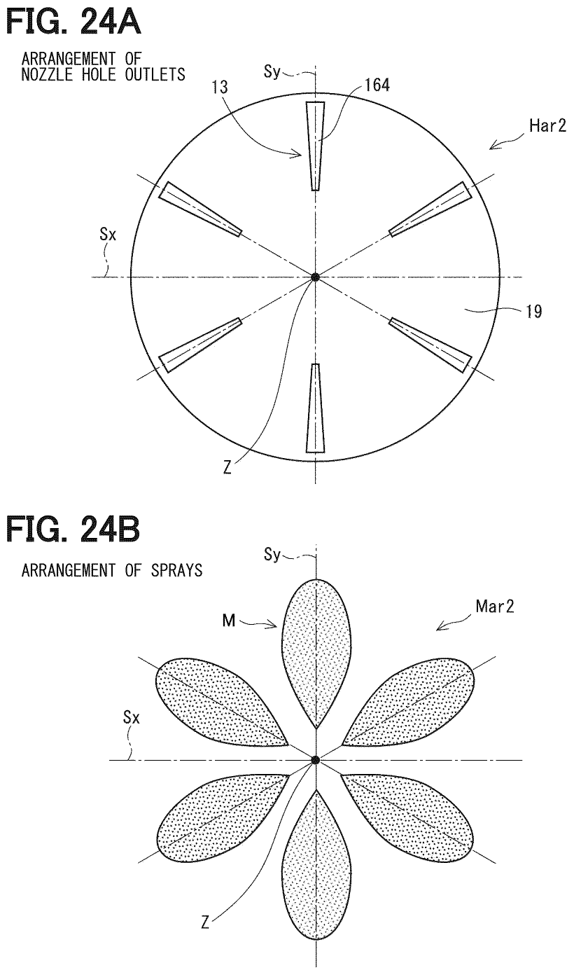

In the arrangements Har2 of the nozzle hole outlet of the second embodiment, trapezoidal rectangular nozzle hole outlets 164 are arranged radially. The trapezoidal nozzle hole outlet 164 may be replaced with the triangular nozzle hole outlet 165. Correspondingly, a radial spray arrangement Mar2 is formed as shown in FIG. 24B. In this spray arrangement Mar2, a spray range in the circumferential direction is wider than in the spray arrangement Mar1 of the first embodiment.

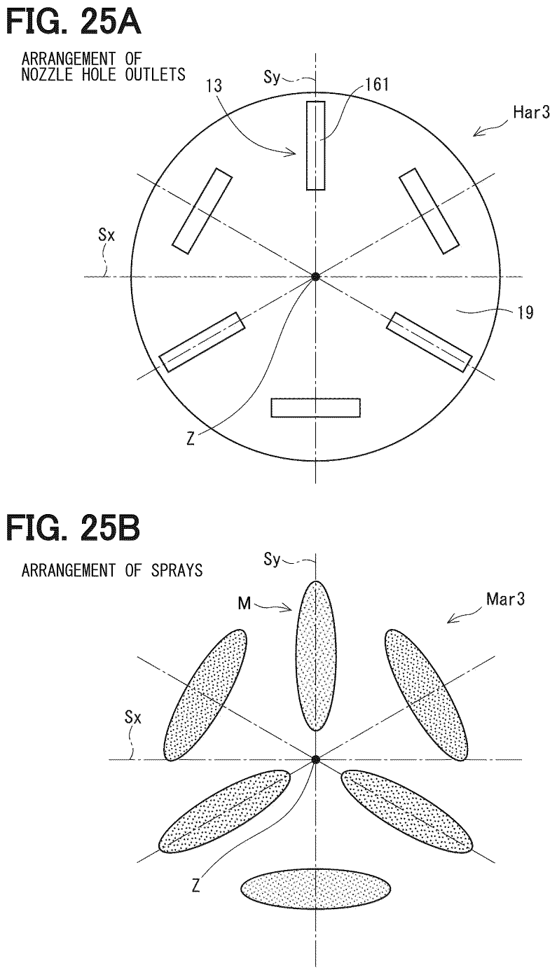

In arrangements Har3 of the nozzle hole outlet of the third embodiment, major axes of the nozzle hole outlets 161 of the three alternately arranged nozzle holes 13 are arranged in the radial direction with respect to the valve axis Z. That is, two or more specific nozzle holes 13 out of the specific nozzle holes 13 have the major axis of the nozzle hole outlet 161 radially arranged with respect to the valve axis Z. The other three nozzle holes 13 are arranged such that the major axis of the nozzle hole outlet 161 is perpendicular to the radial direction. Also, the arrangements Har3 of the nozzle hole outlet are symmetrical with respect to the symmetry plane Sy. Correspondingly, as shown in FIG. 25B, the spray arrangement Mar3 is formed by combining a Y-shaped arrangement and a triangular arrangement. Uniformity is improved in this spray arrangement Mar3.

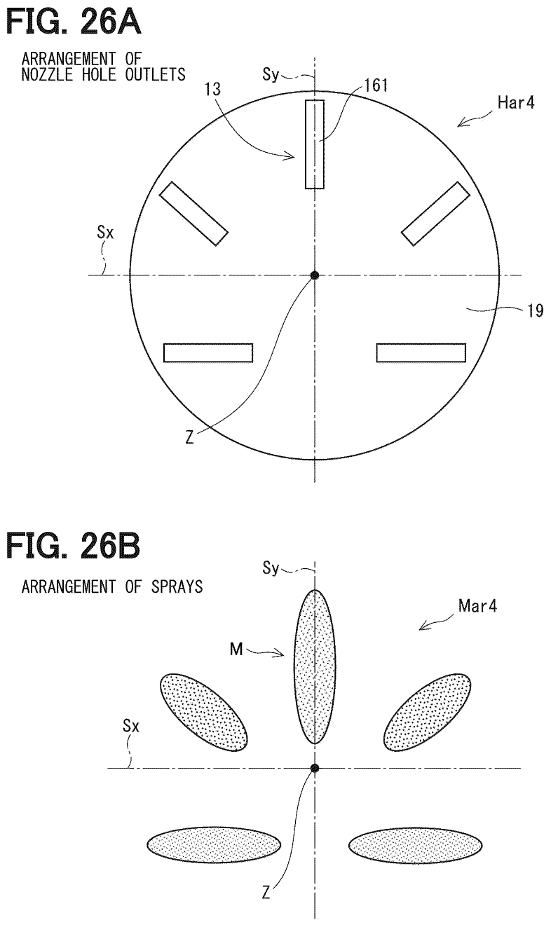

Next, as shown in FIG. 26A, in arrangements Har4 of the nozzle hole outlet of the fourth embodiment, five nozzle hole outlets are arranged asymmetrically with respect to the center, which is suitable for the side mounting type of the fuel injection valve. More specifically, on one direction (an upward direction in FIG. 26A) of the reference plane Sx passing through the valve axis Z, three nozzle hole outlets 161 are arranged radially symmetrically to the center, and on the other direction (a downward direction in FIG. 26A) of the reference plane Sx, two nozzle hole outlets 161 are arranged parallel to the reference plane Sx. Also, the arrangements Har4 of the nozzle hole outlet are symmetrical with respect to the symmetry plane Sy. Correspondingly, as shown in FIG. 26B, a spray arrangement Mar4 centered on one direction (an upward direction in FIG. 26B) of the reference plane Sx is formed. Therefore, the spray arrangement Mar4 can be arranged in a desired space according to a positional relationship between the combustion chamber and the fuel injection valve in the side mounting type.

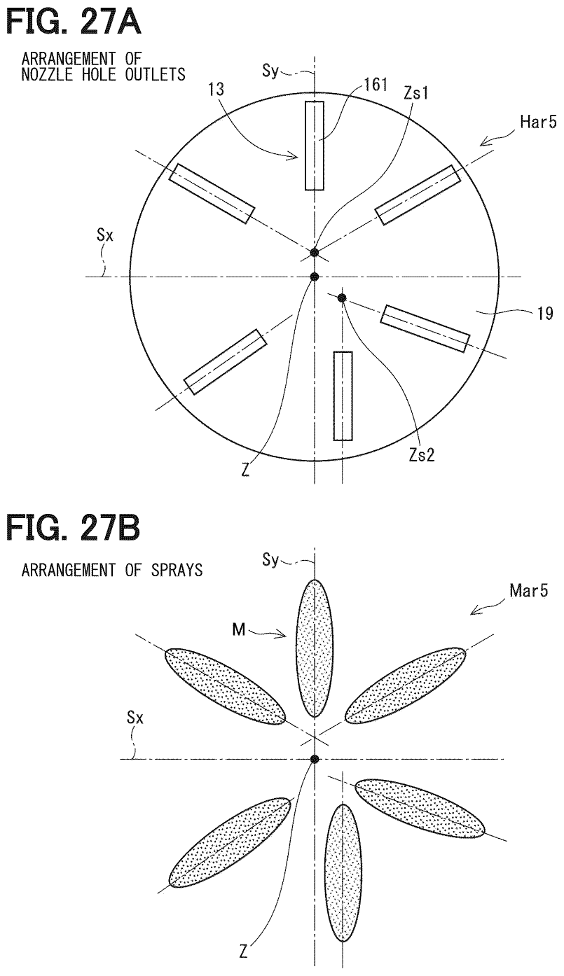

The first to fourth embodiments assume a model arrangement, but in a realistic design, there are reasons such as avoiding interference with other parts in engine installation and aiming for a more precise spray arrangement, minor modifications from an ideal placement may be required. Therefore, in arrangements Har5 of the nozzle hole outlets of the fifth embodiment shown in FIG. 27A, for example, the major axes of two or more nozzle hole outlets are arranged radially to arbitrary axes Zs1, Zs2. The arbitrary axes are shifted from the valve axis Z.

Thus, the arrangements of the nozzle hole outlet of the specific nozzle holes 13 according to the present embodiment may not be strictly radial around the valve axis Z, nor may not be strictly symmetrical with respect to the symmetry plane Sy. However, the arrangement of the fifth embodiment is not completely random, and is roughly arranged radially around the valve axis Z as a whole.

### Other Embodiments

(a) In the fuel injection valve of the present disclosure, all of the nozzle holes may not be specific nozzle holes, and as described above, even if general nozzle holes other than the specific nozzle holes may be included in the nozzle holes. In short, it is sufficient that at least one nozzle hole among the nozzle holes satisfies the requirements for the specific nozzle hole. For example, in FIG. 16, if one specific nozzle hole is used to rotate the spray wide-angle direction, an air supply passages are secured on both sides in the circumferential direction. As a result, the spray contraction can be avoided.

(b) The shape of the specific nozzle hole 13 of the basic example shown in FIGS. 4A, 4B, and 5 is an example. An angle between wall surfaces 14 of the nozzle holes 14 facing each other in a cross section taken along the major axis Ha and a cross section taken along the minor axis Hb of the nozzle hole outlet 16 is not limited to the illustrated example, and may be set in any way.

(c) Configurations of each member in the fuel injection valve is not limited to that shown in FIG. 1, and may be modified to obtain the same function. For example, adjacent members made of the same material may be formed separately or integrally.

(d) The fuel injection valve of the present disclosure may be applied not only to direct-injection gasoline engines, but also to diesel engines, port-injection gasoline engines, and the like.

The present disclosure should not be limited to the embodiment described above. Various other embodiments may be implemented without departing from the scope of the present disclosure.

The present disclosure has been made in accordance with the embodiments. However, the present disclosure is not limited to such embodiments and configurations. The present disclosure also encompasses various modifications and variations within the scope of equivalents. Furthermore, various combination and formation, and other combination and formation including one, more than one or less than one element may be made in the present disclosure.

What is claimed is:

1. A fuel injection valve comprising:
a nozzle centered on a valve axis and including
a suck chamber provided at a bottom of a fuel passage,
nozzle holes extending through a nozzle hole inlet formed in a bottom surface of the suck chamber to a nozzle hole outlet formed in a nozzle outer wall and configured to inject fuel in the fuel passage, and
a valve seat formed annularly around the suck chamber; and
a needle reciprocatable along the valve axis inside the nozzle to open and close the valve seat to switch between injecting and shutting off fuel, wherein
at least one of the nozzle holes is a specific nozzle hole,
the nozzle hole outlet of the specific nozzle hole has a flat shape with a major axis and a minor axis,
a nozzle hole axis is a straight line connecting a center of the nozzle hole inlet and a center of the nozzle hole outlet,
in a projection of the specific nozzle hole in a direction of the nozzle hole axis,
a cross-sectional length of the nozzle hole outlet is longer than a cross-sectional length of the nozzle hole inlet in a cross section, which is in a major axis direction of the nozzle hole outlet and passes through the nozzle hole axis, and
a cross-sectional length of the nozzle hole outlet is shorter than a cross-sectional length of the nozzle hole inlet in a cross section, which is in a minor axis direction of the nozzle hole outlet and passes through the nozzle hole axis,
an area of the nozzle hole inlet is larger than an area of the nozzle hole outlet, and
the specific nozzle hole has an area ratio of 1.5 or more, and the area ratio is a ratio of the area of the nozzle hole inlet to the area of the nozzle hole outlet.

2. The fuel injection valve according to claim 1, wherein
a shape of the nozzle hole inlet of the specific nozzle hole is a circular shape.

3. The fuel injection valve according to claim 1, wherein
the nozzle includes a plurality of specific nozzle holes.

4. The fuel injection valve according to claim 3, wherein
two or more of the specific nozzle holes have major axes of nozzle hole outlets arranged radially with respect to an arbitrary axis.

5. The fuel injection valve according to claim 4, wherein
all of the specific nozzle holes have major axes of nozzle hole outlets arranged radially with respect to an arbitrary axis.

6. The fuel injection valve according to claim 1, wherein
a wall surface of the specific nozzle hole is formed with straight lines in the cross section, which is in the major axis direction of the nozzle hole outlet and passes through the nozzle hole axis, and the cross section, which is in the minor axis direction of the nozzle hole outlet and passes through the nozzle hole axis in a range that is at least a range excluding 20% from the nozzle hole inlet and 20% from the nozzle hole outlet in a nozzle hole length from the nozzle hole inlet to the nozzle hole outlet.

7. The fuel injection valve according to claim 1, wherein
the range is an entire range of the nozzle hole length.
